(19) United States
(12) Patent Application Publication
(10) Pub. No.: US 2007/0156731 A1
(43) Pub. Date: Jul. 5, 2007

(54) Automatic project management application

(75) Inventor: Lior Ben-Zeev, Holon (IL)

Correspondence Address: ABELMAN, FRAYNE & SCHWAB, 666 THIRD AVENUE, 10TH FLOOR, NEW YORK, NY, 10017, US

(73) Assignee: SAP AG

(21) Appl. No.: 11/317,776

(22) Filed: Dec. 23, 2005

(51) Int. Cl. G06F 7/00

(52) U.S. Cl. 707/101

(57) ABSTRACT

In computer-implemented project management, defined tasks are associated with data elements. Elapsed time intervals are computed, during which data elements are checked-out by project members. A project management software application automatically determines an indication of progress of respective associated tasks, based on the elapsed time intervals. The technique supports concurrent management of multiple projects, in which data elements are shared.

### BACKGROUND OF THE INVENTION

1. Field of the Invention

This invention relates to computer-implemented project management. More particularly, this invention relates to improvements in automatically recording project activity for use by a project management entity.

2. Description of the Related Art

The need to manage large and complex projects has led to the development of many software applications that partially automate project management functions. This software typically has both data storage and management capabilities. It purports to assist in such functions as project planning, budgeting, time and resource allocation and scheduling, cost tracking, and report generation. Some applications are comprehensive, while others focus on particular aspects of project management. For example, in the domains of scheduling and workflow, critical path software has been used for many years.

Typically, project management software is electronically linked to its users. Indeed, some applications are groupware-oriented, designed to facilitate collaboration through such modalities as email, video, chat, writing and drawing systems. Many project management applications rely heavily on electronic messaging to record and maintain project status.

A representative disclosure is U.S. Pat. No. 5,548,506, issued to Srinivasan, which proposes to automate various tasks of project management coordination, using a core piece of software known as the AMPS system. The AMPS system runs on a host server computer system and interacts with a messaging system such as electronic mail, fax, etc. Once the AMPS system has been configured for the work environment, all interactions with it by project team members occur via messages. First, the AMPS system compiles multi-project plans into a multi-project database, and tracks the ownership of projects, tasks and resources within the plans. Second, the AMPS system performs automatic check-in of resource requests. If resource availability limits are exceeded then resources are re-allocated to projects based on priorities, and project plans are accordingly changed. Third, the database is processed periodically to send out reminders and project status reports. Fourth, the databases are continuously updated based on status changes reported by project members.

### SUMMARY OF THE INVENTION

One requirement of known systems that track progress of a project and report its status is the need for individual project members to register project-related activities with a management entity, which can be the project management software application itself. This step is typically performed manually or at best in a computer-assisted mode. Even when aided by modern computer interfaces, activity reporting remains tedious, error-prone, and is even susceptible to fraud.

According to disclosed embodiments of the invention, computer-implemented methods and systems are provided for automatically accumulating and reporting task activities by members of a project to a project management software application.

In some aspects of the invention, a project comprises tasks that are associated with particular data elements, e.g., directories and files, by the assignment of task identifiers to the data elements. The activities of project members with respect to the data elements are automatically monitored in a source control environment. Access to data elements (check-out) triggers the monitor a first time. Completion of work on the data elements (check-in) triggers the monitor a second time to cause a report of the member's activity relating to the respective tasks to be transmitted automatically to a generic project management application.

The invention provides a computer-implemented project management method, wherein projects being managed have defined tasks and stored data elements, which is carried out by associating each of the data elements with a task, determining an elapsed time interval during which one of the data elements is checked-out by one of the project members of the project, and using a project management software application to compute an indication of progress of the respective task associated with the one data element based on the elapsed time.

An aspect of the method includes managing an additional project using an additional project management software application, wherein the data elements are accessible to project members of both projects. The method includes informing the additional project management software application when the one data element is checked-out by the one project member.

Another aspect of the method includes communicating attributes of the data elements to the project management software application and the additional project management software application upon occurrence of an event affecting at least one of the attributes.

A further aspect of the method includes accumulating the elapsed time interval in a time-management report.

In one aspect of the method, determining an elapsed time interval includes executing a version control application adapted for checking in and checking out the data elements, and, using the version control application, detecting a check-out of the one data element, and thereafter detecting a check-in of the one data element.

Yet another aspect of the method is carried out following detection of a check-out by detecting inactivity with respect to the one data element during at least a predetermined time interval.

In an additional aspect of the method, detecting inactivity includes establishing an inactivity threshold time interval responsively to user activity statistics.

Still another aspect of the method includes adjusting the elapsed time interval responsively to detection of inactivity.

An additional aspect of the method associating includes assigning task identifiers to the data elements.

The invention provides a computer software product for management of a project having project members, defined tasks and stored data elements, the product including a computer-readable medium in which computer program instructions are stored, which instructions, when read by a computer, cause the computer to associate each of the data elements with a respective one of the tasks of the project, to determine an elapsed time interval during which one of the data elements is checked-out by one of the project members of the project, and to execute a project management software application to compute an indication of progress of the respective task of the one data element based on the elapsed time.

The invention provides a computer system for project management, wherein a project being managed has project members, defined tasks and stored data elements, including a server linked to a plurality of computers operated by the project members. The server is operative to associate each of the data elements with one of the tasks, to detect a check-out of one of the data elements by one of the computers, to detect a check-in of the one data element, to determine an elapsed time interval between the check-out and the check-in, and to report the elapsed time interval with respect to the one task to a project management entity.

One aspect of the computer system includes a version control application executing in the server that is adapted to check in the data elements and check out the data elements.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a block diagram of a system for automatically tracking project-related activities in accordance with a disclosed embodiment of the invention;

FIG. 2 is a flow chart illustrating a method of automatically reporting project-related activities to a project management entity in accordance with a disclosed embodiment of the invention;

FIG. 3 is a block diagram of a portion of the system shown in FIG. 1, which is adapted for managing multiple projects concurrently in accordance with an alternate embodiment of the invention;

FIG. 4 is a flow chart illustrating a method for adjusting credit for project activities in accordance with a disclosed embodiment of the invention; and

FIG. 5 is a block diagram illustrating a system for automatically and concurrently tracking project-related activities by multiple project managers in accordance with an alternate embodiment of the invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code, which embodies aspects of the present invention, is typically maintained in permanent storage, such as a computer readable medium. In a client-server environment, such software programming code may be stored on a client or a server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications network, such as the Internet. In addition, while the invention may be embodied in computer software, the functions necessary to implement the invention may alternatively be embodied in part or in whole using hardware components such as application-specific integrated circuits or other hardware, or some combination of hardware components and software.

System Overview.

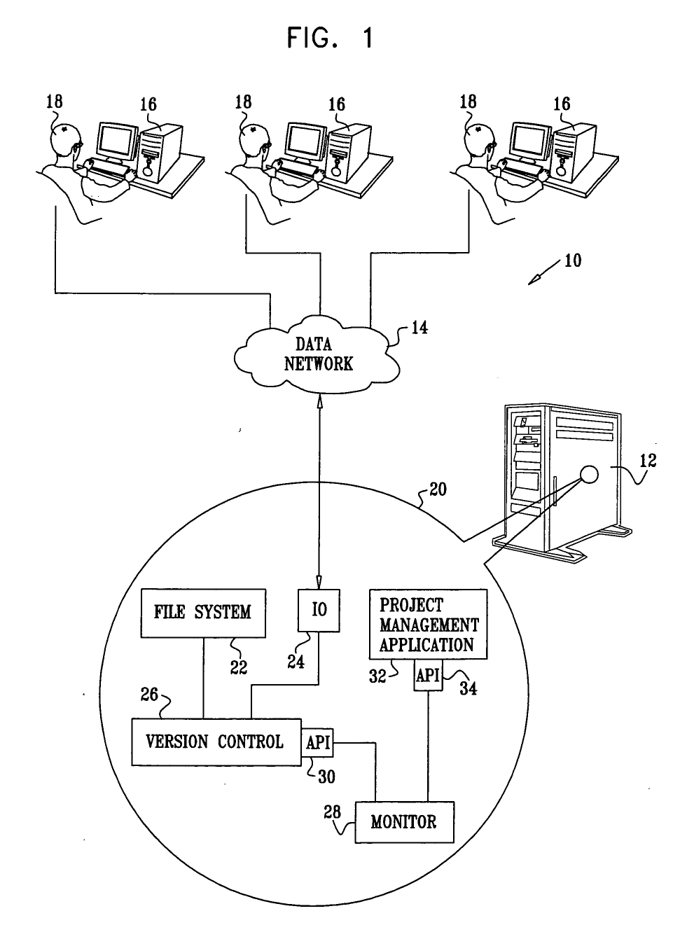

Turning now to the drawings, reference is initially made to FIG. 1, which is a block diagram of a system 10 for automatically tracking project-related activities in accordance with a disclosed embodiment of the invention. The system 10 can be embodied as one or more general purpose computers. In a representative configuration, a server 12 is linked via a data network 14 to any number of workstations or computers 16, under the respective control of project members or users 18. However, the principles of the invention are not limited to traditional client-server arrangements, but may be applied in many system architectures.

For example, the system 10 can be implemented in a complex organization using Netweaver™ portal technology, available from SAP AG of Walldorf, Germany, in cooperation with the Design Time Repository (DTR) of the Java™ development infrastructure (JDI). The DTR handles file versioning to ensure that all developers are working from the same set of code. Developers access a central service via the NetWeaver Developer Studio, check out files, produce new versions in the local file system, and check in the files after successful local testing. The DTR enables comparison of versions, and provides a revision history. In some configurations of the DTR, one can manage different versions of a development object in the same repository, multiple releases of a software component, and in the context of the present invention, manage multiple users making modifications to the same development object with conflict detection. Each state of software component development is represented in one workspace. The information about the state of a workspace can be propagated to other workspaces in order that multiple development teams using different instances of the DTR can be synchronized and managed.

### Embodiment 1

The system 10 typically includes a memory 20, which may be localized in the server 12 or distributed among the server 12 and the computers 16 in many combinations, as is known in the art. In any case the memory 20 contains objects corresponding to the following functional blocks, which are responsive to activities of the users 18. A file system 22 contains various data elements, e.g., directories and files, which are accessed during project-related activities of the users 18. These accesses are mediated conventionally by the server's operating system, shown as an I/O block 24, and moderated by a generic version control application 26. A monitor 28, executing automatically, for example as a daemon or other background process, constantly monitors the activities of the version control application 26, which are exposed via an application programming interface 30 (API). A project management application 32, which is responsible for accumulating the activities of the users 18, receives automatic communications from the monitor 28 as the users begin and end various tasks. Of course, as noted above, the project management application 32 may be responsible for many other functions relating to a project. The monitor 28 can interact with the project management application 32 via an application programming interface 34. Alternatively, other known interprocess communication techniques may be employed in different combinations among the monitor 28, the version control application 26, and the project management application 32, generally depending on the capabilities of the latter two.

Operation.

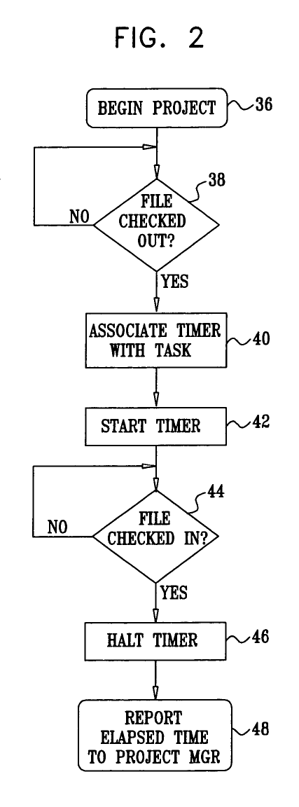

Reference is now made to FIG. 2, which is a flow chart illustrating a method of automatically reporting project activities to a project management entity, in accordance with a disclosed embodiment of the invention. The project management entity is typically an executing software application. At initial step 36 preliminary matters are dealt with. A project is initiated, tasks defined, and project members assigned to perform the tasks. Project management software and version control software are configured. In particular, task identifiers are assigned to all data elements that will be accessed by the project members during the course of the project. This step can be accomplished by a procedure shown in Listing 1.

The following process steps are performed automatically, and shown in a linear sequence for clarity of presentation. However, it will be evident that many of them can be performed in parallel, asynchronously, or in different orders. Indeed, it is necessary that the inventive process track different project activities being concurrently conducted by many project members.

Control proceeds to delay step 38 where check-out of a file (or other data element) by a project member is awaited. Files are issued to project members in a source control environment, which provides for data coherency, as the same data may be requested and modified from time to time by more than one project member. Generic version control software is typically used for file check-out. Check-out information is typically obtained via an interface to the version control application being employed.

When a file is issued to a project member, at step 40 a timer is associated with the current task to which the file relates. The timer can be implemented in any known way, for example as a software listener on an event, or as an electrical timing circuit. In the event that more than one file associated with the current task is checked out, an overlap is flagged. No additional timers are initiated. However, the last file to be checked in measures activity for the current task.

Next, at step 42, the timer is started, corresponding to initiation of project activities by the project member with respect to the task.

Control now proceeds to delay step 44, where it is awaited for the current file that was checked out in delay step 38 to be returned or checked in. As in check-out, check-in information is typically obtained via an interface to the version control application being employed.

Next, at step 46, the timer that was started at step 42 is halted, and elapsed time determined, which is simply the time interval between the check-out at the completion of delay step 38 and the check-in at the completion of delay step 44.

Next, at final step 48 the project management software is apprised of the elapsed time relating to the current task, and typically is informed which project member conducted the current task-related activities. The project management software accumulates the task-related time, and appropriately credits the project member in a time management report. The project management software also updates its task tracking to estimate the percentage completion of the task in question, in order that it, or an operator can monitor task completion over time. In some embodiments, the project management software can simply measure time spent on the task against an estimated time requirement to complete the task. Alternatively, the project management software may be integrated with an automatic test suite, whereby task completion is measured, at least in part, based on how many tests in the suite the file in question passes successfully.

### Embodiment 2

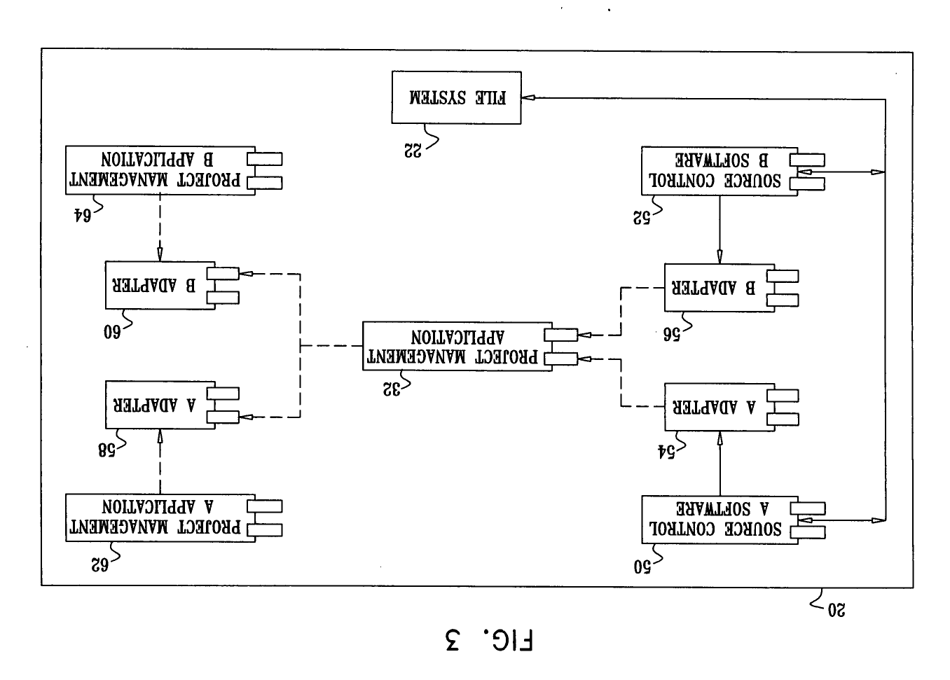

Reference is now made to FIG. 3, which is a block diagram of a portion of the system 10 (FIG. 1), in which the memory 20 is provided with functional objects enabling multiple projects to be managed concurrently in accordance with an alternate embodiment of the invention.

In this embodiment the project management application 32 simultaneously supports two source control environments, represented as version control applications 50, 52. Adapters 54, 56 provide interfaces between the project management application 32 and the version control applications 50, 52, respectively. The adapters 54, 56 are programmed to monitor activities of the users 18 (FIG. 1) with respect to files checked out via the version control applications 50, 52, and to trigger the task-related steps caused by check-in and check-out as described in the discussion of FIG. 2. Adapters 58, 60 provide respective links between the project management application 32 and two subsidiary project management applications 62, 64, which are responsible for developing task management reports for their respective project in response to events signaled by the adapters 54, 56. The task management reports are transmitted to the project management application 32.

File check-out and check-in procedures that can be used in this embodiment are given as pseudocode fragments, in Listing 2 and Listing 3, respectively. Inspection of these fragments shows no direct access to the project management application 32 by the users 18, nor is there any requirement for additional actions of the users 18 to update the project management application 32. These functions are handled automatically, triggered by interactions between the users 18 and the file system 22. Optionally, the automatic updates provided by these procedures may be supplemented by information that is provided manually by the project team members and/or information regarding task completion that is provided automatically by other applications, such as automated software test applications.

In this embodiment there are provisions for detecting inactivity with respect to a file that has been checked out. These can be implemented, for example, as keystroke monitors, by detection of modifications to a buffer or to a journal file, or combinations of these techniques. The purpose of these provisions is to detect prolonged inactivity with respect to a checked-out file. Here prolonged inactivity means failure of activity relating to the checked-out file to occur within a predefined time interval. Such inactivity would create a suspicion that, although the file has been checked out, presumably to work on its assigned task, in fact no work is being done. In such a case the report that is sent to the project management application 32 would be misleading. Therefore, the report may be automatically adjusted, or even omitted. Alternatively, the report can be flagged as being of dubious reliability This issue may be handled by ignoring intervals exceeding a given size, during which no user activity relating to the file occurred. Such an interval is referred to as an “inactivity threshold”. In some embodiments, the inactivity threshold can be constant, preferably 30 minutes. Alternatively, the inactivity threshold can be adaptively determined according to user statistics. For example, the activity threshold can be established and revised by monitoring average time that elapses between keystrokes, between modifications to file or buffers, or between file check-in and check-out.

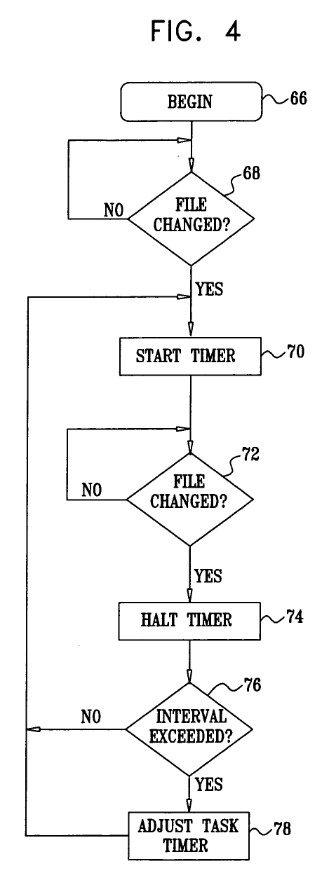

Reference is now made to FIG. 4, which is a flow chart illustrating a method for adjusting credit for project activities in accordance with a disclosed embodiment of the invention. The method begins concurrently at initial step 66 with the initiation of delay step 44 (FIG. 2), and control proceeds immediately to delay step 68, where a change in the content of a currently checked-out file by the user is awaited. In some applications this can be readily determined by accessing the modified attribute of the file or its content. In other applications, it may be necessary to monitor a memory buffer that is established by the application, or to monitor a window in order to determine user activity.

Next, at step 70 a timer is started. Control then proceeds to delay step 72, where another change in the content of a currently checked-out file by the user is awaited.

Next, at step 74 the timer begun in step 70 is halted. Control now proceeds to decision step 76, where it is determined if the elapsed time interval between step 70 and step 74 exceeds a predetermined interval, typically 30 minutes.

If the determination at decision step 76 is negative, it is concluded that the user has been actively working at the current project management task. No further action is needed. Control returns to step 70 to begin a new iteration.

If the determination at decision step 76 is affirmative, then it is concluded that the user has not actively working at the current project management task. Control proceeds to step 78, where a negative adjustment is made to the timer that was established in step 40 (FIG. 2) corresponding to the time interval between step 70 and step 74. In this manner inactive user time is not counted in project management reports. Control then returns to step 70 to begin a new iteration.

### Embodiment 3

In a one-to-many situation, a single resource is shared by more than one project. Conventionally, the manager of each project would manage the resource independently of the other mangers. Indeed, a project manager might be oblivious that one of its resources was being utilized by other projects, except that such a resource might be reported as unavailable, e.g., resulting from a file being locked. This difficulty is solved by expansion of the functions of the monitor 28 (FIG. 1). Hooks are provided that provide each project manager with information about the use of resources by other project manager.

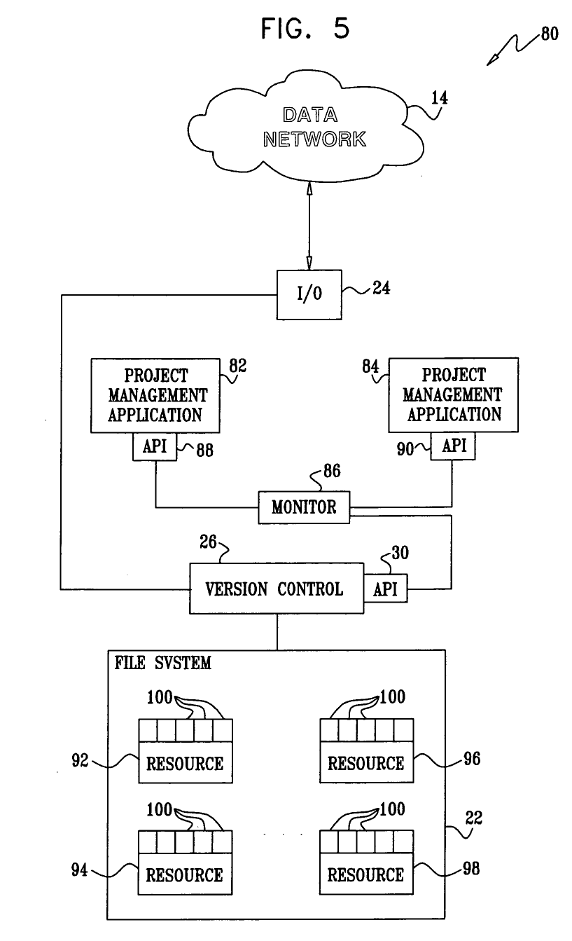

Reference is now made to FIG. 5, which is a block diagram illustrating a system 80 for automatically and concurrently tracking project-related activities by multiple project managers in accordance with an alternate embodiment of the invention. Any number of projects, represented by a first project and a second project being managed respectively by project management applications 82, 84, are connected to a resource monitor 86 via application programming interfaces 88, 90, respectively. The project management applications 82, 84 and the application programming interfaces 88, 90 need not be identical, but could run under different platforms. The monitor 86 is linked to the version control application 26, which distributes a plurality of resources 92, 94, 96, 98 in the file system 22. These resources are shared resources, accessible for use by either of the two projects. They are managed by the version control application 26, which coordinates their uses by both projects. The version control application 26 relates to the monitor 86 via the application programming interface 30. The method described with reference to FIG. 4 is employed by each of the project management applications 82, 84 when resources in the file system 22 are accessed by their respective associated project members.

Now, when a resource, for example, the resource 92, is accessed by for use by the project being managed by the project management application 82, the monitor 86 has hooks that provides the project management application 84 information, e.g., metadata, that allows it to assess the present status of the resource 92, and to analyze and project its future availability. Thus, the project management application 84 is informed when the resource 92 is checked out and checked in by a project member of the first project, that is the project being managed by the project management application 82. Conversely, the project management application 82 is informed in like manner. In consequence, the reports and projections produced by the project management applications 82, 84 are more accurate than would be the case had information about shared resources not been available.

In some embodiments, the project management applications 82, 84 communicate to one another the status of resources, using known interprocess communication methods. The intercommunication is typically event-driven, triggered upon check-out, check-in, or modification of a resource. When shared resources under development are checked out by project members of one of the projects, there are many possible consequences to the other project. For example, when the development of such a resource is the responsibility of the other project, modification of the resource could be blocked until it is checked-in. This could affect a critical path of the other project. Interprocess communication among the project management applications 82, 84 facilitate automatic prioritization of the availability of such a shared resource among the projects.

In other embodiments, the resources 92, 94, 96, 98 have associated attributes 100, for example the status of being checked-out, the identity of the project or projects currently employing the resource, and time of last modification. In this sense, each resource is “aware” of its current status. The attributes 100 can be proactively communicated from the resources 92, 94, 96, 98 to the project management applications 82, 84, for example upon occurrence of an event that results in a change one or more of the attributes 100.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

Computer Program Listings

Listing 1
ProjectManagement.associate (file, Task);

If (!tasksListInDB.contain(file))

updateInDB(file, Task)

else

InsertToDB(file, Task).

Listing 2
SourceControlAdapter.check-out(file,userID);

AutomaticProjectManagement.check-out(file,userID)
If (!tasksListInDB.contain(file))

Return error “File not associated with task”

else

startTime=GetCurrentTime
InsertToDB(file,startTime).

Listing 3
SourceControlAdapter.check-in(file);

AutomaticProjectManagement.check-in(file)
task = getTasksListFromDB(file)
fileData = getFromDB(file)
finishTime = GetCurrentTime
workingTimeOnTask= finishTime-fileData.startTime
ProjectManagementAdapter.sendWorkingReport

(task,workingTimeOnTask, fileData, userId)

deleteInDB(file)

1. A computer-implemented project management method, wherein projects being managed have project members, defined tasks and stored data elements, the method comprising the steps of:
associating each of said data elements with a respective one of said tasks of a project;
determining an elapsed time interval during which one of said data elements is checked-out by one of said project members of said project; and
using a project management software application to compute an indication of progress of said respective task of said one data element based on said elapsed time.

2. The method according to claim 1, further comprising the steps of:
managing an additional project using an additional project management software application, wherein said data elements are accessible to project members of said project and to project members of said additional project, the method further comprising the step of:
informing said additional project management software application when said one data element is checked-out by said one project member.

3. The method according to claim 2, wherein said data elements have attributes, further comprising the step of communicating said attributes to said project management software application and said additional project management software application upon occurrence of an event affecting at least one of said attributes.

4. The method according to claim 1, further comprising the step of accumulating said elapsed time interval in a time-management report for said one project member.

5. The method according to claim 1, wherein said step of determining an elapsed time interval comprises the steps of:
executing a version control application adapted for checking in said data elements and checking out said data elements;
detecting a check-out of said one data element via said version control application; and
thereafter detecting a check-in of said one data element.

6. The method according to claim 5, further comprising the step of following performance of said step of detecting a check-out, detecting inactivity with respect to said one data element during at least a predetermined time interval.

7. The method according to claim 5, further comprising the steps of:
determining an inactivity threshold time interval responsively to user activity statistics; and
following performance of said step of detecting a check-out, detecting inactivity with respect to said one data element during at least said inactivity threshold time interval.

8. The method according to claim 6, further comprising the step of adjusting said elapsed time interval responsively to said step of detecting inactivity.

9. The method according to claim 1, wherein said step of associating comprises assigning task identifiers to said data elements.

10. A computer software product for management of a project having project members, defined tasks and stored data elements, the product comprising a computer-readable medium in which computer program instructions are stored, which instructions, when read by a computer, cause the computer to associate each of said data elements with a respective one of said tasks of said project, to determine an elapsed time interval during which one of said data elements is checked-out by one of said project members, and to execute a project management software application to compute an indication of progress of said respective task of said one data element based on said elapsed time.

11. The computer software product according to claim 10, wherein said instructions further cause said computer to manage an additional project by executing an additional project management software application, wherein said data elements are accessible to project members of said project and to project members of said additional project, and said instructions further cause said computer to inform said additional project management software application when said one data element is checked-out by said one project member.

12. The computer software product according to claim 11, wherein said data elements have attributes, wherein said computer is further instructed to communicate said attributes to said project management software application and said additional project management software application upon occurrence of an event affecting at least one of said attributes.

13. The computer software product according to claim 10, wherein said instructions further cause said computer to accumulate said elapsed time interval in a time-management report for said one project member.

14. The computer software product according to claim 10, wherein said instructions further cause said computer to detect a check-out of said one data element, and thereafter to detect a check-in of said one data element.

15. The computer software product according to claim 14, wherein said instructions further cause said computer to detect inactivity with respect to said one data element following said check-out thereof during at least a predetermined time interval.

16. The computer software product according to claim 14, wherein said instructions further cause said computer to detect inactivity with respect to said one data element following said check-out thereof during at least a threshold time interval and to establish said threshold time interval responsively to user activity statistics.

17. The computer software product according to claim 15, wherein said instructions further cause said computer to adjust said elapsed time interval responsively to a detection of inactivity with respect to said one data element.

18. A computer system for project management, wherein a project being managed has project members, defined tasks and stored data elements, comprising a server linked to a plurality of computers operated by said project members said server being operative to associate each of said data elements with one of said tasks, to detect a check-out of one of said data elements by one of said computers, to detect a check-in of said one data element, to determine an elapsed time interval between said check-out and said check-in, and to report said elapsed time interval with respect to said one task to a project management entity.

19. The computer system according to claim 18, wherein said project management entity is a software application executing in said server.

20. The computer system according to claim 18, further comprising a version control application executing in said server that is adapted to check in said data elements and to check out said data elements, and said server is operative to detect said check-out and to detect said check-in using said version control application.
